(19) United States
(12) Patent Application Publication
(10) Pub. No.: US 2014/0195305 A1
(43) Pub. Date: Jul. 10, 2014

(54) METHOD FOR CREATING A DIGITAL SOLUTION FOR A BUSINESS

(71) Applicants: Yehoshua Lehavi, Woodland Hills, CA (US); Christopher Michael O'Connell, Encino, CA (US); Devin Laurance Deer, Los Angeles, CA (US); Mario Weck-Samkian, La Crescenta, CA (US); Michael Christopher Frazier, Los Angeles, CA (US); Richard Campbell Abronson, Woodland Hills, CA (US); Joshua Ray DeWald, West Hills, CA (US); Fabian Edgardo Schonholz, Thousand Oaks, CA (US)

(72) Inventors: Yehoshua Lehavi, Woodland Hills, CA (US); Christopher Michael O'Connell, Encino, CA (US); Devin Laurance Deer, Los Angeles, CA (US); Mario Weck-Samkian, La Crescenta, CA (US); Michael Christopher Frazier, Los Angeles, CA (US); Richard Campbell Abronson, Woodland Hills, CA (US); Joshua Ray DeWald, West Hills, CA (US); Fabian Edgardo Schonholz, Thousand Oaks, CA (US)

(21) Appl. No.: 13/738,953

(22) Filed: Jan. 10, 2013

(51) Int. Cl. G06Q 10/06

(52) U.S. Cl. CPC G06Q 10/0637
USPC 705/7.36

(57) ABSTRACT

A method of creating a digital solution, such as a website, for a business where business specific information is collected separately before digital solution information is collected that pertains to the creation and delivery of the digital solution. The business specific information collected may be industry specific, stored separately in the system from digital solution information, and the digital solutions created for optimal presentation on customer computer devices with different configurations through means such as transcoding.

### BACKGROUND OF THE INVENTION

The present invention relates to a computer method for creating digital solutions for businesses, such as for example a website.

It has long been known that the creation of digital solutions, such as a website, exceeds the computer skills and technical abilities of many small businesses who want or need to create a website. Many such businesses do not have the knowledge, training, software or equipment to program and create their own websites, especially with a professional look and feel. While hiring another person or organization to create a website is an option, the expense of doing so may be prohibitive for many small businesses. Furthermore, relying upon someone else to have to update, maintain, or make any changes to a website can be an inconvenience to a small business.

In response to the well known need for an easy and affordable way to create a website without computer programming skills a number of website creation services have previously arisen in the marketplace. These website services generally offer a user a selection of one or more website templates to choose from. A small business user operating a computer connected to a network, such as the internet, will connect to the server of a website template service. The user must then proceed through a number of steps which typically include (1) selecting a domain name, (2) creating an account, (3) providing credit card payment information, (4) choosing a website design template, (5) making design choices about the template (e.g. color scheme), (6) entering user information to be incorporated into the website design template, and (7) generating the completed website pages with the user information included in the code (e.g. html) for the website pages, and (8) publishing (i.e. “launching”) the finished website.

The pre-existing website template service described above does not adequately address the need for an easy and affordable way for the ordinary small business user with little or no knowledge of computers and the internet to create a website. The pre-existing website template services are inadequate because they make the user's participation in the website creation process primarily focused on the technical and aesthetic features of the website pages (e.g. domain name, template selection, template features, etc. . . . ). For many small business users this can be tedious, intimidating, confusing and uncomfortable. Many small business users who need or want a website may be computer and website novices who are uncomfortable and confused by having to make choices for unfamiliar things such as domain names, hosting plans, email addresses, web page design choices, etc. . . . .

Another shortcoming of the pre-existing website template services is the difficulty involved in the small business making changes to their website after it has been initially created. The pre-existing website template services incorporate information specific to the user as part of the static code of the web pages created during the website creation process. Accordingly, any change to the website of a user will require the user to again go through the entire process of creating a website to generate new website pages with revised static code to reflect updated business information. This means entering user specific information again to generate a new static code for the web pages. This is time consuming and tedious for the user. The present invention overcomes the aforementioned problems of the prior art.

### BRIEF SUMMARY OF THE INVENTION

As described herein, the present invention is a method for creating a digital solution for a user, such as a website, using a computer system. While the computer system and methods described herein are primarily directed at the creation of websites, it is important to note that the digital solutions are not limited to just websites. Digital solutions may extend to many other things that can be created and/or displayed by electronic devices such advertisements, QR codes, software applications, etc. . . . .

A first key aspect of the present invention is that the digital solution creation process is focused primarily on obtaining business specific information (hereinafter “BSI”) that is independent of digital solution information (hereinafter “DSI”). By first collecting BSI the digital solution creation process becomes much more familiar, comfortable and easier for the small business user.

A second key aspect of the present invention is the separation of BSI from DSI. In this way the BSI can be easily updated by the user without having to revisit the DSI in the computer system. The separation of BSI from DSI not only in collection, but also storage in the computer system, helps to facilitate simple and rapid updates by a small business to an existing digital solution, or the creation of a new digital solution.

### BRIEF DESCRIPTION OF THE SEVERAL VIEWS OF THE DRAWINGS

FIG. 1 is an illustration of an exemplary networked computer system the present method invention may be implemented on.

FIG. 2 is an illustration of some exemplary display devices that digital solutions of the present invention may be displayed on.

FIG. 3 is a flow chart diagram illustrating the general operation of a preferred embodiment of the present invention where business information is collected first before digital solution information.

FIG. 4 is a flow chart diagram illustrating the general operation of a preferred embodiment of the present invention where a business question set query is transmitted prior to transmittal of business questions from selected business question sets.

FIG. 5 is a flow chart diagram illustrating the general operation of a preferred embodiment of the present invention where a preview of the digital solution is transmitted prior to creation of digital solution.

FIG. 6 is a flow chart diagram illustrating the general operation of a preferred embodiment of the present invention where transmitted business questions and digital solution questions are industry specific based on a prior industry selection.

FIG. 7 is an illustration of an exemplary business interview page displaying a business question set query.

FIG. 8 is an illustration of an exemplary business interview page displaying a an industry identification query and business question set query.

FIG. 9 is an illustration of an exemplary business interview page displaying business questions and answer means.

### DETAILED DESCRIPTION OF THE INVENTION

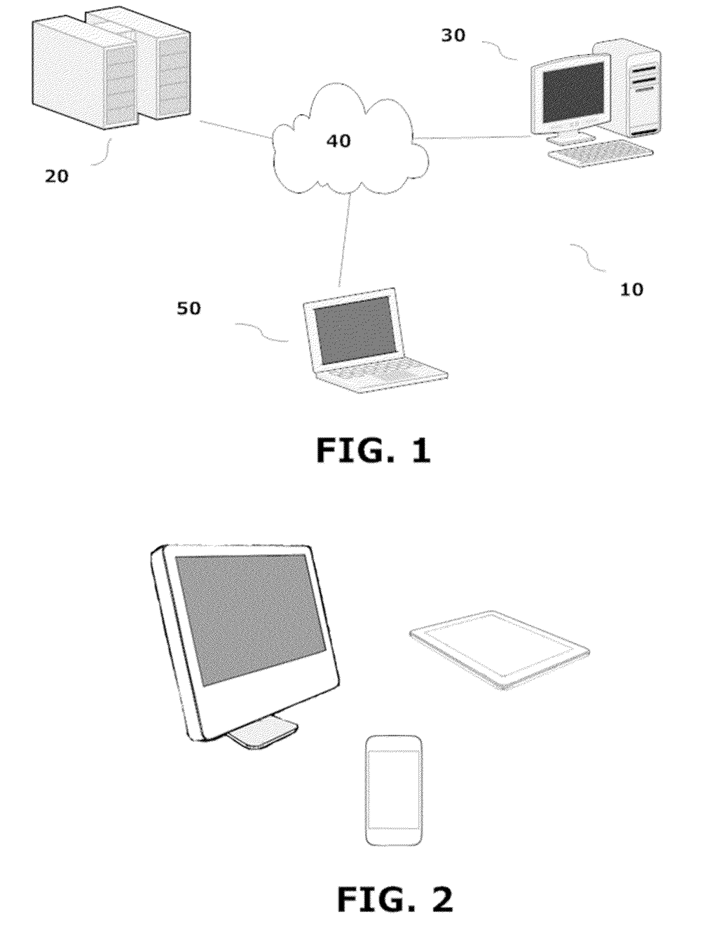

FIG. 1 illustrates an exemplary system architecture of a computer system 10 for implementing the present invention which includes a business computer 30 connected over the internet 40 to a platform computer 20 having a platform memory, and a platform application (i.e. software application) running on a platform processor. One or more customer computers 50 may also connect over the internet 40 to platform computer 20.

A business computer 30, or a customer computer 50, is contemplated to be a computing device which has a memory, a processor running computer software such as an internet web browser, an input device and a display. Business computer 30 or customer computer 50 may be, by way of example and not limitation, a personal computer such as desktop or laptop computer, or a mobile computing device such as a tablet, smart phone or personal digital assistant. Business computer 30 or customer computer 50 may include a number of different input devices, depending upon the particular type and model of computing device, such as for example a computer mouse, computer keyboard, stylus, or touch sensitive display. It is contemplated that business computer 30 or customer computer 50 may also have a variety of different displays depending upon the particular type of device, such as shown for example in FIG. 2.

In an exemplary embodiment of the present invention platform computer 20 may be a single network server computer, multiple network server computers, or a cloud computing platform, such as for example Amazon Web Services. In the preferred embodiment of the present invention platform computer 20 has at least one processor that runs a platform software application (“PSA”) that utilizes at least one database in platform memory. Platform computer memory may include primary operational memory such as RAM and ROM, and also secondary storage memory such as, for example and without limitation, hard disk drives, flash memory drives, optical drives, tape drives, magnetic and optical media (e.g. CD/DVD-ROM, magnetic tape) etc. . . . .

In an exemplary embodiment it is contemplated that business computer 30 may connect and communicate with the PSA by sending a request over internet 40 to a hosting domain for the PSA. Upon receiving a request at the hosting domain from a business computer 30 the PSA transmits to business computer 30 a PSA home page which is displayed on requesting business computer 30. It is contemplated that the PSA may also utilize a session identifier, such as a session token or cookie, to identify and track the particular session with the business computer. The PSA home page transmitted to business computer 30 includes a sign-up option for registering with the PSA to create a new digital solution account, and also a sign-in option for previously registered users.

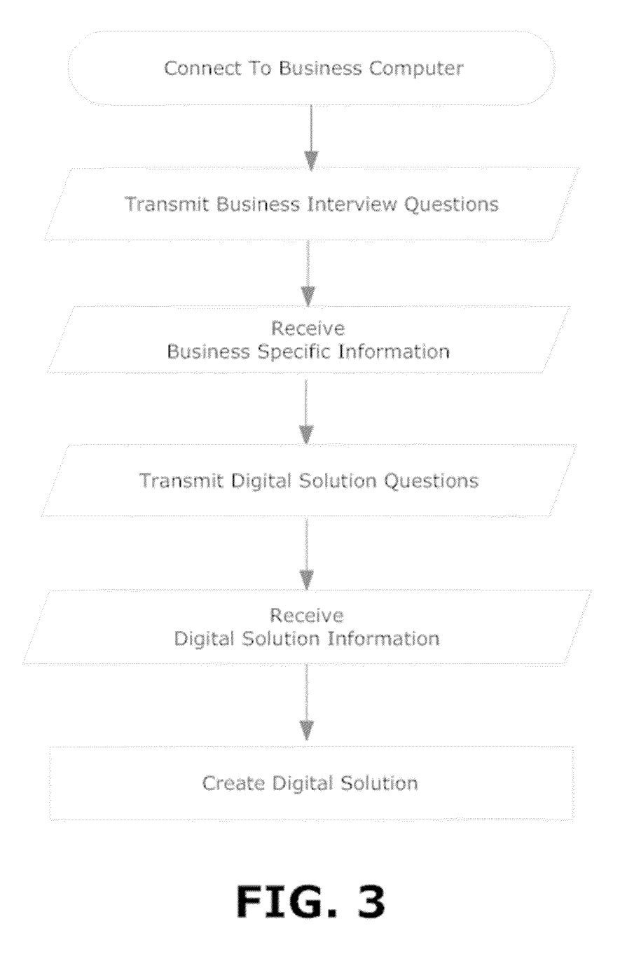

Referring to FIG. 3, upon receiving a communication from a connected business computer 30 that the sign-up option has been selected PSA will transmit to business computer 30 a business interview page containing at least one question pertaining to BSI that is independent of information concerning the digital solution to be created, such as for example a website. BSI is information about real world business characteristics and functions, such as the business name, business location, business staff, business services and products, etc. . . . . Thus, BSI is information that can be accurately communicated without any reference to the features or characteristics of a digital solution such as a website. It is a distinguishing aspect of the present invention that a business interested in creating a digital solution, such as a website for example, will first be asked to provide BSI before addressing the creation of a digital solution. BSI is information that all business owners or staff, regardless of technical aptitude with digital solutions, will be familiar with and comfortable providing in response to questions about the business. Accordingly, in a preferred embodiment of the present invention the PSA shall during the creation of a digital solution first transmit to business computer 30 a business interview page containing at least one business question seeking BSI.

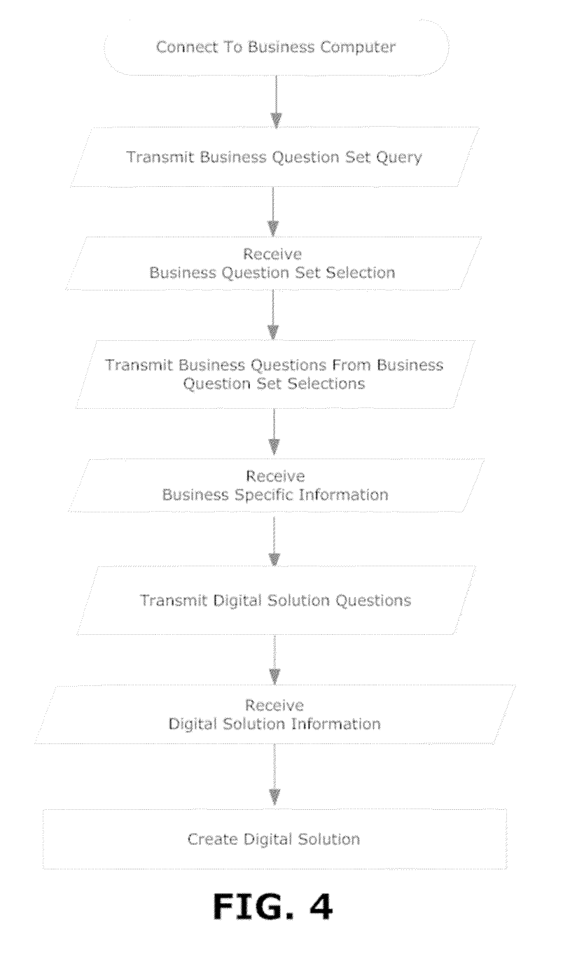

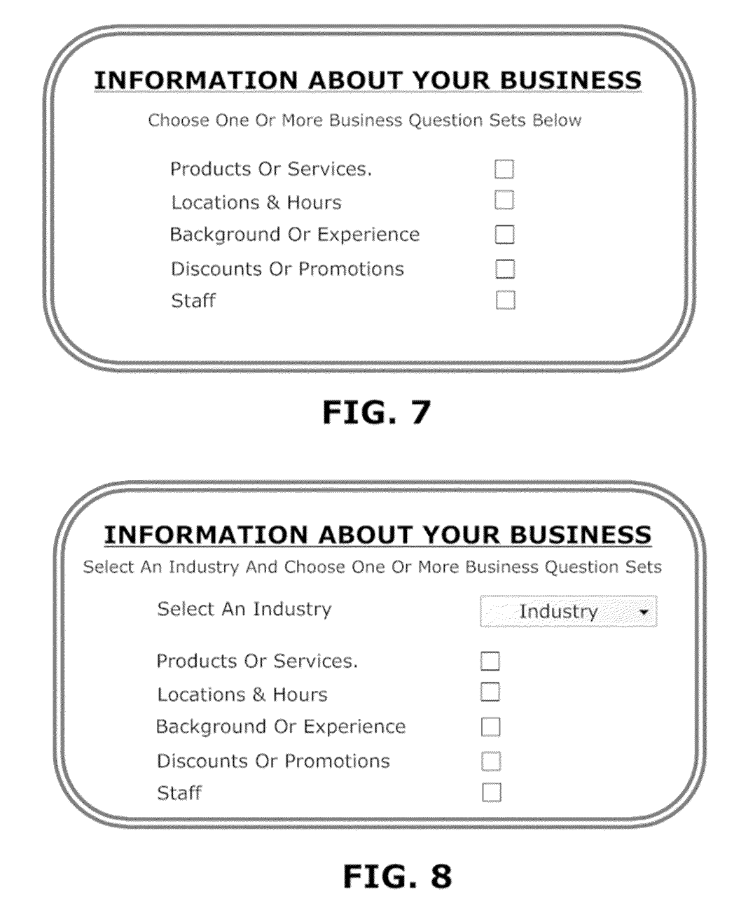

Referring to FIG. 4, it is further contemplated that business questions may be organized and stored in platform memory as topical business question sets, and that a business interview page may allow for a business to choose in response to a business question set query which business question sets the business wants to respond to. By way of example, and not limitation, a business may want to provide BSI on its locations and products, but not its staff. Business questions about staff may be grouped into a staff business questions set, that is separate from the business questions set(s) concerning business locations and products. The business may then choose to include, or exclude, from the business questions it provides answers to the staff business question set. As shown in FIG. 7 the business may indicate which industry question sets the business wants to respond to, by way of example and not limitation, through a business question set query that entails a user clicking on a check box next to business question set titles or descriptions that are displayed on a business interview page. This may cause a selected business question set to open or close with respect to displaying the particular business questions in the set. Alternatively, a user's response to a business question set query returns a business question set selection to the PSA (e.g. through selecting a “submit” button). The PSA may then transmit to the business computer a business interview page showing only the business questions from the business question sets selected. Such business questions would have been previously stored in platform memory in association with business question sets.

As shown in FIG. 9 adjacent to each business question displayed on a business interview page it is contemplated that there would be an answer means for the business to respond to the question with BSI. The answer means may be, for example, a text box, a check box, or a radio button. However, the answer means may also be more complex, including a means to attach and upload files (e.g. image, audio, or video). The business may, for example, respond to a business question by using a business computer 30 input device such as a keyboard, mouse, stylus, camera, microphone, or touch screen. It is contemplated that a business may provide certain BSI in response to business questions through use of an API that connects to and communicates with a third party service which the business may have already provided BSI to, such as for example LinkedIn or Facebook.

It should be noted that BSI may be collected through the display of business questions on a single business interview page, or on multiple business interview pages that are proceeded through sequentially, with a user being able to navigate back and forth between pages. Upon completing a business interview page by providing BSI through the answer means to the business questions, the BSI would be transmitted to the PSA (e.g. by clicking on a “submit” button). Upon receipt of the BSI the PSA stores the BSI in a business location of platform memory, preferably in a relational database. The BSI is preferably stored in association with a business identifier unique to the business, which may be a temporary session identifier if the registration process has not been completed and a permanent business identifier has not yet been assigned to the business.

After collection of all relevant BSI the PSA transmits to business computer 30 one or more digital solution creation pages. A digital solution creation page collects digital solution information (“DSI”) from a business concerning the particular digital solution the business is interested in creating. As with business interview pages it is contemplated that the display of digital solution questions may be on a single digital solutions interview page, or on multiple digital solutions interview pages that are proceeded through sequentially, with a user being able to navigate back and forth between pages.

It is contemplated that a digital solution may be a website for a business. However, a digital solution is not limited to just websites. A digital solution may be any form of digital product that incorporates BSI, such as for example, QR codes, digital advertisements, digital communications, or digital files that may be used in the creation of tangible products such as printed materials (e.g. brochures, business cards, etc. . . . )

In the situation where the digital solution to be created is a website, it is contemplated that a digital solution creation page shall display on business computer 30 at least one website template. If a plurality of templates is available to choose from there will be a selection means for the business to choose a template, such as for example a check box adjacent to a template choice. Upon receipt from business computer 30 of a template selection the PSA shall store said template selection in a digital solution location of platform memory, preferably in a relational database. The template selection is stored in the database in association with a business identifier unique to the business, which may be a temporary session identifier if the registration process has not been completed and a permanent business identifier has not yet been assigned to the business.

It is further contemplated that a digital solution creation page for a website may permit the business to make certain choices regarding customizing the appearance of a selected template, such as for example color, font properties, arrangement of web page elements, menu selection, different themes or skins, etc. . . . . Such template customization choices by a business are DSI that is transmitted from business computer to the PSA and stored in a digital solutions location of platform memory, preferably in a relational database in association with the unique business identifier.

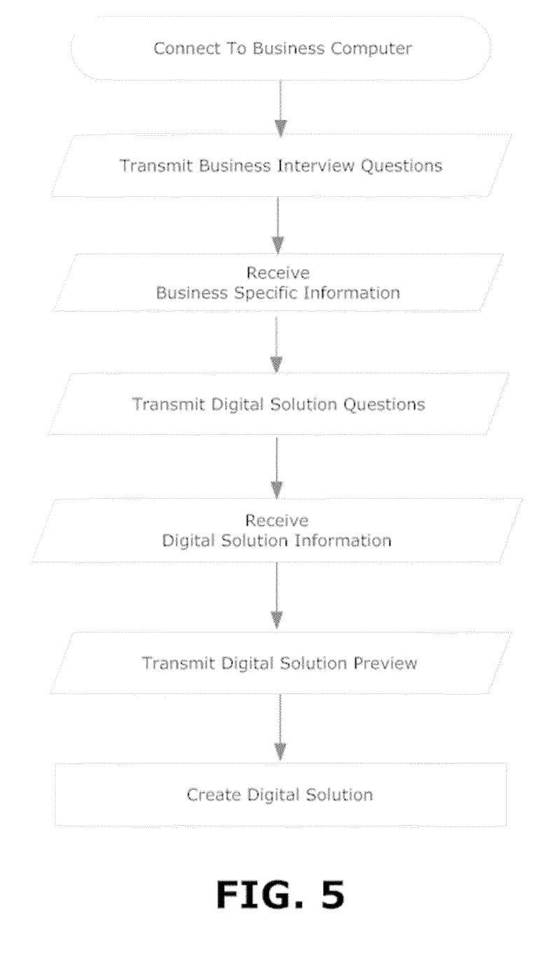

As illustrated in FIG. 5 is further contemplated that a digital solution creation page may display a preview of the digital solution with its appearance, possibly as customized by business. Said preview of the digital solution may be updated as a business user makes any customizations to the digital solution. In a preferred embodiment of the invention where the digital solution is a website it is contemplated that a digital solution creation page would have the ability to display a preview of a digital solution with different templates, or template customizations, with just one action (e.g. “1-Click”) by the business user. For example a business user may with just a single selection from a drop-down list of available templates change the digital solution preview. Importantly, the display of a preview of a different template selection will not require the business user to again enter any BSI which has already been collected and stored in platform memory separately from DSI. Thus it is easy and convenient for a business to quickly change and preview different digital solutions incorporating BSI with the present invention.

It is further contemplated in an embodiment of the present invention that a digital solution creation page may allow a user to preview different versions of the digital solution as they would appear on different customer computer 50 configurations. Particularly, it is contemplated that the PSA will be able to transmit for display on a digital solution creation page a preview of the digital solution as it may appear on a customer computer display having a certain size and aspect ratio, such as for example a desktop, laptop, tablet or smart phone display, such as shown for example in FIG. 2. The preview of a customer computer 50 display may be appropriately scaled for viewing on a business computer 30 display. On a digital solution creation page a business user may choose which customer computer configuration to preview, such as for example by making a selection on the page of a customer computer configuration from a drop-down list, or from graphical icons representing computer configurations. Doing so may cause a device format indicator to be received by the PSA, which would then transmit a digital solution preview to the connected business computer in formatted in accordance with the device format indicator.

Once the business user has completed choosing and customizing the appearance of the digital solution, it is contemplated that a digital solutions creation page transmitted to business computer 30 shall display one or more publication property questions to business. Publication properties are the digital solution information concerning how the digital solution will be published. Some or all publication properties may be decided by a business user depending upon the particular digital solution being created.

In the case of a digital solution that is a website the publication properties would include such things as the internet domain name where the website being created could be accessed by customer computers. It is contemplated that for such publication properties as internet domain names the PSA would have the ability to determine the availability of proposed internet domain names received from business computer in response to publication property questions, and registration abilities for any selected and available internet domain names.

As with business questions, publication property questions would have an answer means for the business user to respond to the questions, such as for example a text box, check box, radio button etc. . . . . . Business user answers to publication property questions would be communicated from the business computer to the PSA which would process and/or store such answers as DSI in a digital solution location of platform memory, preferably in a relational database. The publication property data would be stored in association with a business identifier unique to the business, as well as other DSI related to the particular digital solution for the business.

Upon determining that all necessary publication properties of the digital solution have been received from business and stored in platform memory, the PSA will then transmit to user a digital solution confirmation page. The digital solution confirmation page shall include a means for business to input any required payment information for the digital solution created, such as for example a form to collect credit card information, billing address, etc. . . . . In the event that business has not previously registered an account with the system there shall be means for a business user to input any required information for account registration, such as for example a user name, password, contact information (e.g. email address) etc. . . . . In the event that the business is already registered, and no payment is required for the digital solution created, the digital solution confirmation page may simply display a confirmation that the digital solution has been successfully created and/or published.

In a second preferred embodiment of the invention the BSI and DSI that a business provides in creating a digital solution are determined at least in part by an industry identifier stored in platform memory, preferably in a relational database, in association with the business. An industry identifier indicates the industry that the business operates in, such as for example, accounting, legal, medical, advertising, manufacturing, software development etc. . . . .

Businesses that operate in different industries typically will have different BSI that will be relevant to a digital solution the business is interested in creating. For example, a manufacturer operating a factory will have different information that it may want to include in a digital solution directed to its customers (e.g. manufacturing capacity, equipment and materials, quality control etc. . . . ) than the information a medical practice would want included in a digital solution directed to prospective patients (e.g. areas of specialty, hospital privileges, insurance accepted, etc. . . . ). It is contemplated that the system of the present invention will have stored in platform memory business questions that are targeted to particular industries. Such business questions could be the result of market research (e.g. customer or business surveys) about the information most important to customers of businesses in a particular industry. Accordingly, businesses that connect to the system of the present invention will identify what industry they are in so that a business interview page may be transmitted and displayed on the business computer that presents business questions for obtaining the most relevant and desired BSI for the digital solution to be created.

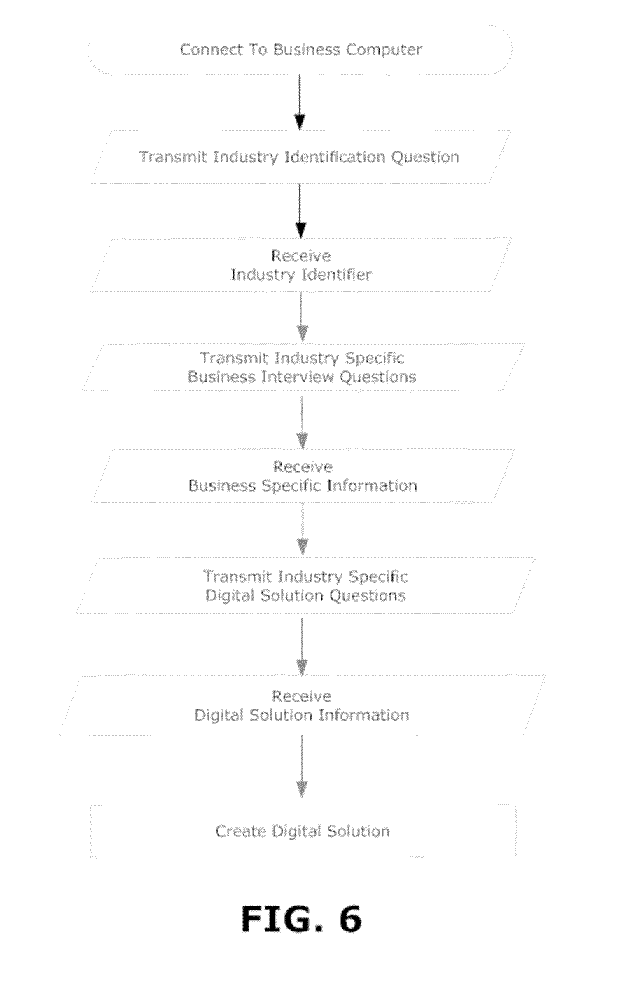

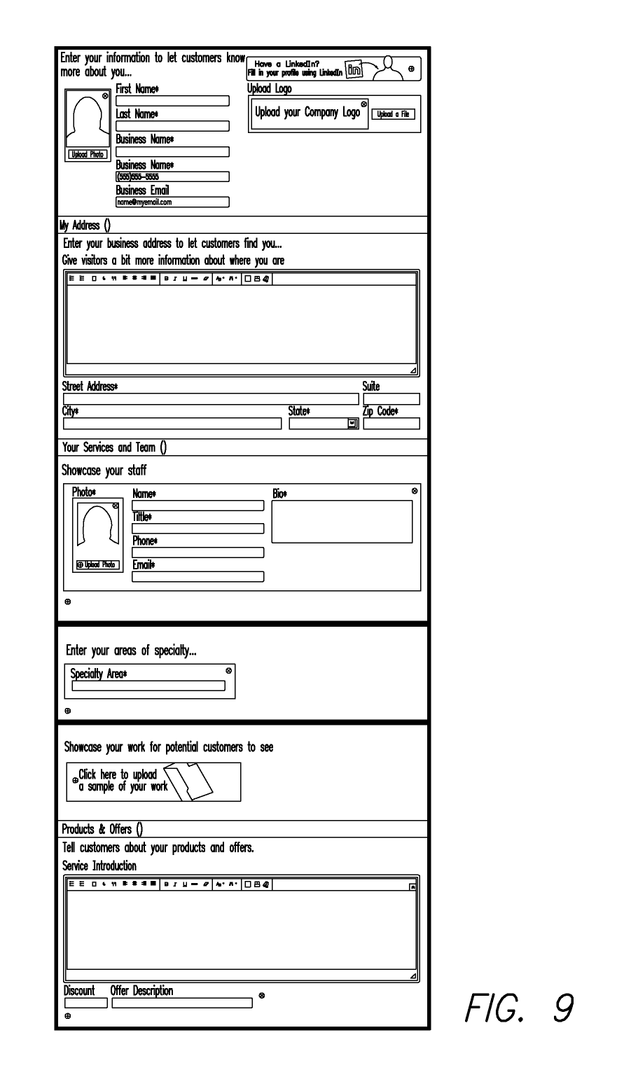

As shown in FIG. 6 for example, it is contemplated that the PSA would transmit to a connected business computer an industry identification question which may, for example, be in the form of a drop-down selection list. See FIG. 8 for example. Such a drop-down selection list would be populated by a list of pre-determined industry identifiers (i.e. accounting, legal, medicine, manufacturing, automotive, etc. . . . ) that were previously stored in platform memory. Once the PSA receives from business computer 30 an industry identifier it shall retrieve from platform memory at least one business question that was previously stored in association with said industry identifier, and shall transmit to business computer 30 a business interview page with industry specific business questions.

It is contemplated that a business interview page may organize any industry specific business questions into topical business question sets, and allow for a business to choose which business question sets the business wants to respond to. The business may indicate which industry specific business question sets the business wants to respond to, by way of example and not limitation, through clicking on a check box next to business question set titles or descriptions that are displayed on the business interview page. Doing so may cause the selected business question set to open or close with respect to displaying the particular business questions in the set. Alternatively, the selections may be transmitted to the PSA (e.g. through selecting a “submit” button). The PSA may then transmit to the business computer a business interview page showing only the industry specific business questions from the business question sets selected.

It is also contemplated that the DSI may be industry specific. Different industries may have different elements that are appropriate for inclusion in a digital solution. For example, in the situation of creating websites, website templates for the music industry may incorporate images (e.g. of musical instruments or performers) that would be very different from the images used in a website for the legal profession (e.g. images of court rooms, legal books, scales of justice etc. . . . ).

It is therefore contemplated that in an embodiment of the present invention the templates available for selection are stored in platform memory, preferably in a relational database, in association with an industry identifier. As with industry specific business questions, industry specific templates can be the result of market research (e.g. customer or business surveys) as to the most important desirable features of a template in that industry. Accordingly, in such an embodiment the digital solution creation page shall display on business computer at least one website template that is associated with the industry identifier selected by the business. In addition to the benefit of displaying only industry specific templates that contain the most industry relevant features on a digital solution creation page, this can also greatly simplify the template selection process for the business by sparing the business from having to sort through numerous templates which may be in appropriate for the industry the business is in.

As stated above, in an embodiment of the present invention BSI is stored in platform memory separately from DSI. It is contemplated that BSI is only combined with DSI by PSA in runtime when transmitting a digital solution a customer computer in response to a request received for the digital solution. In the case of, for example, the digital solution being a website this means that the individual pages of the website are not created prior to receiving a request from a customer computer 50 for a website page. An individual web page is only created in run time upon receipt of a request, at which time the PSA combines the relevant DSI (e.g. template information) with BSI (e.g. business information to appear on website page) to create the website page and transmit it to customer computer 50. In other words, prior to receiving a request for the website page from a customer computer 50 the BSI is not “hard coded” into website page source code that is then stored in platform memory waiting to be requested. The BSI will be combined with the DSI and transmitted to a customer computer for display only upon the PSA receiving a request from the customer computer 50. While the aforementioned embodiment is preferred, the main aspects of the present invention can still be practiced in an embodiment where the separately collected and stored BSI and DSI are used to create a completed digital solution that is stored in platform memory prior to a request being received from a customer computer 50.

It is further contemplated that the present invention may also publish digital solutions using transcoding techniques as are known to those skilled in the art which help ensure that a published digital solution appears and functions optimally on a particular customer computer 50. Specifically, prior to the PSA transmitting a requested digital solution to a customer computer 50 it is contemplated that the PSA shall use device information received from the customer computer as part of the request (i.e. as contained in a customer computer 50 user agent header field) to identify the customer computer characteristics and features (e.g. display size, operating system, etc. . . . ). The PSA shall then publish the requested digital solution by transmitting to customer computer 50 a version of the digital solution that is optimized for the customer computer 50.

It should be noted that in actual implementation of transcoding the optimized digital solutions transmitted to a customer computer 50 are not contemplated to be limited to just the sizes and display aspect ratios shown of generic devices as part of a preview on a digital solution creation page. The transcoding process for transmitting optimized digital solutions to actual customer computer 50 devices may rely upon device specific information previously collected and stored in platform memory regarding the characteristics of known devices (e.g. an Apple iPhone 4s).

It is further contemplated that the invention may utilize responsive web design for digital solutions that are web pages. Specifically, the PSA shall transmit to requesting customer computers web pages that have a layout adaptive to the particular viewing environment on a visitor computer device by utilizing such things as, for example, CSS3 media queries, fluid proportion-based grids, and flexible images, as is know to those skilled in the art of web design.

The above described embodiments of the invention are examples only. Those of ordinary skill in the art may make modifications, variations and changes to the exemplary embodiments without departure from the scope of the claimed invention.

The invention claimed is:

1. A method of creating a digital solution for a business, said method using a computer system that has a platform computer with a platform memory and a platform processor running a platform software application, and comprising:
a first step of said platform software application transmitting to a connected business computer a business question previously stored in platform memory;
a second step of said platform software application receiving from said connected business computer business specific information responsive to said transmitted business question;
a third step of said platform software application transmitting to said connected business computer a digital solution question previously stored in platform memory;
a fourth step of said platform software application receiving from said connected business computer digital solution information responsive to said transmitted digital solution question; and
a fifth step of said platform software application creating said digital solution by combining said business specific information and said digital solution information.

2. The method of claim 1 further comprising a step of said platform software application transmitting a preview of said digital solution to said connected business computer prior to creating said digital solution;

3. The method of claim 2 wherein said preview of said digital solution is transmitted in accordance with a device format indicator received from said connected business computer.

4. The method of claim 1 further comprising the step of said platform software application transmitting said digital solution to a connected customer computer.

5. The method of claim 4 further comprising the step of said created digital solution being stored in platform memory by said platform software application prior to said customer computer connecting.

6. The method of claim 1 further comprising said platform software application storing said business specific information separately from said digital solution information in said platform memory.

7. The method of claim 1 further comprising:
a sixth step of said platform software application receiving a request from a connected customer computer for said digital solution for said business;
a seventh step of said platform software application identifying a configuration of said connected customer computer;
an eighth step of said platform software application creating a transcoded digital solution using said stored digital solution information and said stored business specific information; and
a ninth step of said platform software application transmitting to said customer computer said transcoded digital solution.

8. The method of claim 1 further comprising:
said platform application first transmitting to said connected business computer a business question set query;
said platform application receiving from said connected business computer at least one business question set selection responsive to said business question set query; and
for each business question set selection said platform application transmitting to said connected business computer a business question previously stored in said platform memory in association with said selected business question set.

9. A method of creating a digital solution for a business, said method using a computer system that has a platform computer with a platform memory and a platform processor running a platform software application, and comprising:
a first step of said platform software application transmitting to a connected business computer an industry identification question previously stored in platform memory;
a second step of said platform software application receiving from said connected business computer an industry identifier responsive to said transmitted industry identification question;
a third step of said platform software application transmitting to said connected business computer an industry specific business question previously stored in platform memory in association with said industry identifier;
a fourth step of said platform software application receiving from said connected business computer business specific information responsive to said transmitted industry specific business question;
a fifth step of said platform software application transmitting to said connected business computer an industry specific digital solution question previously stored in platform memory in association with said industry identifier;
a sixth step of said platform software application receiving from said connected business computer digital solution information responsive to said transmitted industry specific digital solution question;
a seventh step of said platform software application creating said digital solution by combining said business specific information and said digital solution information.

10. The method of claim 8 further comprising a step of said platform software application transmitting a preview of said digital solution to said connected business computer prior to creating said digital solution;

11. The method of claim 10 wherein said preview of said digital solution is transmitted in accordance with a device format indicator received from said connected business computer.

12. The method claim 9 further comprising the step of said platform software application transmitting said digital solution to a connected customer computer.

13. The method of claim 12 further comprising the step of said created digital solution being stored in platform memory by said platform software application prior to said customer computer connecting.

14. The method of claim 9 further comprising said platform software application storing said business specific information separately from said digital solution information in said platform memory.

15. The method of claim 9 further comprising:
a sixth step of said platform software application receiving a request from a connected customer computer for said digital solution for said business;
a seventh step of said platform software application identifying a configuration of said connected customer computer;
an eighth step of said platform software application creating a transcoded digital solution using said stored digital solution information and said stored business specific information; and
a ninth step of said platform software application transmitting to said customer computer said transcoded digital solution.

16. The method of claim 9 further comprising:
said platform application first transmitting to said connected business computer a business question set query;
said platform application receiving from said connected business computer at least one business question set selection responsive to said business question set query; and
for each business question set selection said platform application transmitting to said connected business computer a business question previously stored in said platform memory in association with said selected business question set.
